(19) United States
(12) Patent Application Publication
(10) Pub. No.: US 2007/0187436 A1
(43) Pub. Date: Aug. 16, 2007

(54) Retractable extension tube for spray nozzles

(76) Inventor: Frederic M. Oran, Old Brookville, NY (US)

Correspondence Address: Frederic M. Oran, 14 Oak Lane, Old Brookville, NY, 11545-2107, US

(21) Appl. No.: 11/355,535

(22) Filed: Feb. 16, 2006

(51) Int. Cl. B67D 3/00

(52) U.S. Cl. 222/530

(57) ABSTRACT

The present invention is a device that permits the extension tube of a spray nozzle to be retracted by coiling.

### FIELD OF THE INVENTION

The present invention relates generally to spray nozzles and, more particularly, to extension tubes attached thereto.

### BACKGROUND OF THE INVENTION

Extension tubes are widely used with spray nozzles to facilitate easier access to tight spaces and to concentrate the flow of a sprayed substance onto a small target. For example, an extension tube attached to the nozzle of a spray can containing a deicing liquid makes it easier to direct the flow into the keyhole of a frozen lock.

Current extension tubes are often lost or damaged because existing designs do not offer effective means of storing them. As a result, the usefulness of the associated spray can is greatly diminished because the extension tube is no longer available.

Hailey (U.S. Pat. No. 5,772,068) describes a holder for an extension tube affixed to the outside of a spray can. Such a design, though, requires that the tube is laboriously inserted into the spray nozzle before each use, and then consistently returned to the holder after each use. In addition, it exposes the tube to potential damage and clogging by environmental hazards and debris.

Spurlock and Kellogg (U.S. Pat. No. 5,890,631) describe an extension tube with an articulated joint (similar to a flexible drinking straw) that permits the tube to be bent at a right angle or an obtuse angle and taped to the side of the spray can. That design also leaves the extension tube exposed when not in use, subject to potential damage and clogging.

Riley and Riley (U.S. Pat. No. 6,412,657) describe what is essentially a leash for the extension tube, consisting of a ring in which the tube fits at the end of a flexible cord. This design shares Hailey's weaknesses, making unnecessary demands on the user and leaving the extension tube unprotected.

Clearly, an improved design would effectively protect the extension tube and minimize demands on the user.

### BRIEF SUMMARY OF THE INVENTION

The present invention is a device that permits the extension tube of a spray nozzle to be retracted by coiling.

### BRIEF DESCRIPTION OF THE DRAWINGS FIG. I depicts the components of one embodiment of the present invention.

FIG. 2 depicts a top view of one embodiment of the present invention, with the top of the cap removed to show the extension tube coiled, in its fully retracted position.

### DETAILED DESCRIPTION OF THE INVENTION

In one embodiment of the present invention, as depicted in FIG. 1, an extension tube 101 is attached to the nozzle 102 of a spray can 103. The cap 104 of the spray can 103 has an opening 105 in its side through which the extension tube 101 may project when the cap 104 is attached to the top rim 106 of the spray can 103. The cap 104 of the spray can 103 also has an opening 107 in its top through which the head piece 108 may project when the cap 104 is attached to the top rim 106 of the spray can 103. Both the extension tube 101 and the cap 104 may be detached. The spray can 103 may always be operated by pressing downward on the head piece 108, whether the extension tube 101 or the cap 104 is attached or detached.

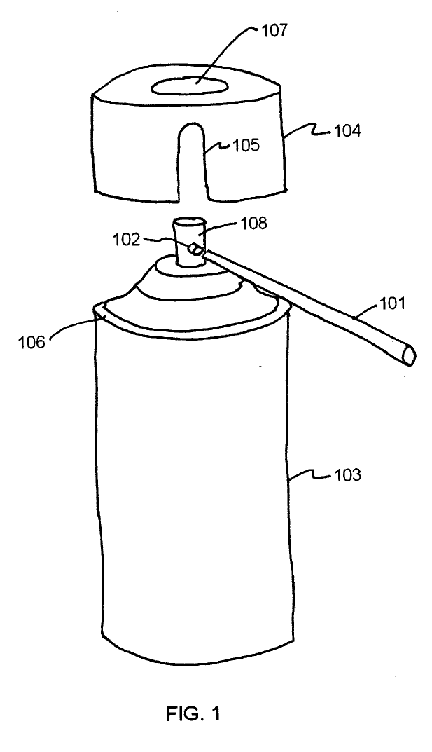

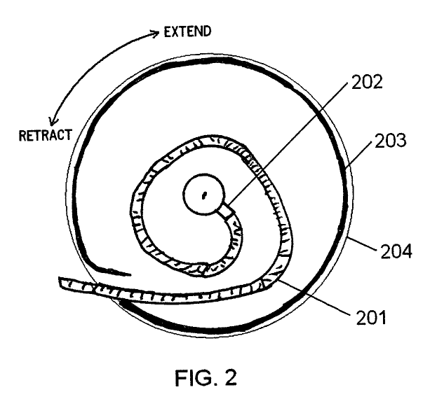

As depicted in FIG. 2, when the extension tube 201 is attached to the nozzle 202 and the cap 203 is attached to the top rim 204, the extension tube 201 may be coiled inside the cap 203 by rotating the cap 203 in one direction. The extension tube 201 may be uncoiled by rotating the cap 203 in the opposite direction, or by detaching the cap 203 from the top rim 204.

While the present invention has been described in terms of specific embodiments thereof, those skilled in the art will appreciate that various changes in form and detail may be made without departing from the intended spirit and scope of the invention as defined in the claims.

I claim:

1. A device for storing an extension tube of a spray nozzle, comprising:
an enclosed space; and
a means of coiling an extension tube of a spray nozzle in said enclosed space.

2. The device of 1 wherein said enclosed space is cylindrical.

3. The device of 1 wherein said enclosed space is a component of a cap of a container.

4. The device of 3 wherein said cap is permanently attached to said container.

5. The device of 3 wherein said cap may be detached from said container.

6. The device of 1 wherein said means of coiling consists of rotating said enclosed space.

7. The device of 1 wherein said extension tube is permanently attached to said spray nozzle.

8. The device of 1 wherein said extension tube may be detached from said spray nozzle.

9. The device of 1 wherein a side of said enclosed space has an opening through which said extension tube may project.

10. The device of 9 wherein said opening has the shape of a circle or an ellipse.

11. The device of 9 wherein said opening is a slot with an open end.

12. The device of 11 wherein said slot has the shape of an upside-down letter “L.”

13. The device of 1 wherein said spray nozzle is operable while said extension tube is coiled.

14. The device of 1 wherein said extension tube has an encircling projection at the end most distant from the spray nozzle such that said encircling projection prevents said extension tube from being completely retracted within said device.
